(19) United States
(12) Patent Application Publication
(10) Pub. No.: US 2014/0133715 A1
(43) Pub. Date: May 15, 2014

(54) DISPLAY SCREEN WITH INTEGRATED USER BIOMETRIC SENSING AND VERIFICATION SYSTEM

(71) Applicant: IDENTITY VALIDATION PRODUCTS, LLC, DAINGERFIELD, TX (US)

(72) Inventors: CLAUDIO R. BALLARD, FORT LAUDERDALE, FL (US); SANDY FLIDERMAN, ALBERTSON, NY (US)

(21) Appl. No.: 14/079,536

(22) Filed: Nov. 13, 2013

Related U.S. Application Data
(60) Provisional application No. 61/726,665, filed on Nov. 15, 2012.

(51) Int. Cl. G06K 9/00

(52) U.S. Cl. CPC G06K 9/00013
USPC 382/124

(57) ABSTRACT

A mobile device with integrated user biometric sensing comprises a casing, a touchscreen and a camera/scanner module. The touchscreen is mounted on the front side of the casing and acts as a display panel and, at the same time, as a touch-sensitive, digitizing input pad. The camera/scanner module is disposed below the touchscreen in a predefined scanning area, and includes a housing, a lens, a photo sensor and signal wires which operatively connect the scanner/camera module to sensing/security circuitry disposed within the casing. When a user presses the top surface of the touchscreen in the scanning area with a fingertip, the lens array focuses an image of a fingerprint of the fingertip onto the photo sensor.

### CROSS-REFERENCE TO RELATED APPLICATIONS

This application claims benefit of U.S. Provisional Application No. 61/726,665, filed Nov. 15, 2012, entitled DISPLAY SCREEN WITH INTEGRATED USER BIOMETRIC SENSING AND VERIFICATION SYSTEM (Atty. Dkt. No. VMVM-31496), the specification of which is incorporated by reference herein in its entirety.

### TECHNICAL FIELD

The following disclosure relates to mobile devices having a touchscreen, and more particularly, to devices wherein the touchscreen includes integrated user biometric sensing.

### BACKGROUND

Modern mobile devices such as “smartphones,” “tablets,” “handhelds,” “e-readers” and the like are characterized by the use of touchscreens that serve as both input devices and display devices. Consumers increasingly favor mobile devices with larger touchscreens but, at the same time, with the smallest possible overall device size (i.e., form factor). These conflicting demands limit the “real estate” space available for the placement of new peripheral devices on such mobile devices. A need therefore exists, for peripheral devices that can be incorporated into the form factor of existing mobile devices to provide additional capabilities without reducing the user experience.

Additionally, as the use of mobile devices by the public grows, so does the need for improved security to prevent unauthorized access to secured content on the device and/or secure accounts accessible via the device. Although the use of basic security measures such as user IDs and passwords is common, these measures are often less secure and less convenient to use than biometric security measures. A need therefore exists, for user biometric sensing on mobile devices and verification systems that may be easily used to control access to the device.

U.S. Pat. No. 7,519,558 to Ballard et al. discloses technology relating to the use of user biometric data. U.S. Pat. No. 7,519,558, including all specification, description, figures and claims, is hereby incorporated by reference.

### SUMMARY

In one aspect thereof, a biometric finger scanner is embedded in or under the display glass (i.e., touchscreen) of a mobile device. This design may incorporate biometric verification into the normal “swipe process” of device initiation, allowing the mobile device to simultaneously perform biometric verification at the time of swipe. In a preferred embodiment, the dual-purpose finger swipe takes place as part of the normal screen/device unlock process that is represented as a virtual “slide bar” on the touchscreen. In another preferred embodiment, the dual-purpose finger swipe takes place as part of the normal screen/device unlock process that is represented as a two-dimensional touch pattern.

In another aspect, a touchscreen-equipped mobile device with integrated user biometric sensing is provided in accordance with the disclosure herein.

In another aspect, a mobile device with integrated user biometric sensing comprises a casing and a touchscreen mounted on a front side of the casing, the touchscreen acting as a display panel and, at the same time, acting as a touch-sensitive, digitizing input pad. A camera/scanner module is disposed below the touchscreen in a predefined scanning area, the camera/scanner module including a housing, a lens, a photo sensor and signal wires which operatively connect the scanner/camera module to sensing/security circuitry disposed within the casing. When a user presses a fingertip against the top surface of the touchscreen in the scanning area, the lens array focuses an image of a fingerprint of the fingertip from the top surface of the touchscreen onto the photo sensor; i.e., it senses user biometric data. An associated security system may then use the sensed biometric information to verify the authenticity of the user and make available on an “assigned rights” basis access to some or all secured content including, files, contacts, images, photos, user names, passwords, etc., that have been administratively assigned with a local application and/or a remote agent. Technology disclosed in U.S. Pat. No. 7,519,558 to Ballard et al. may be utilized in the security system.

In yet another aspect, the mobile device is a smartphone.

In yet another aspect, the mobile device is a tablet device or table computer.

In yet another aspect, the mobile device is a handheld device.

In yet another aspect, after the lens array focuses the image of the fingerprint from the top surface of the touchscreen onto the photo sensor, the photo sensor sends signals representative of the user's biometric data to the sensing/security circuitry of the mobile device.

In yet another aspect, after the photo sensor sends signals representative of the user's biometric data to the sensing/security circuitry of the mobile device, the mobile device compares the user's biometric data to previously stored biometric data corresponding to one or more authorized users of the mobile device and/or accounts accessible via the mobile device.

In yet another aspect, the comparison of the user's biometric data to previously stored biometric data corresponding to one or more authorized users is performed entirely within the mobile device.

In yet another aspect, the comparison of the user's biometric data to previously stored biometric data corresponding to one or more authorized users is performed at least partially via communication with an external networked device.

In yet another aspect, the external networked device is a security server.

In another aspect thereof, a security system is provided for a touchscreen-equipped mobile device having a biometric sensor. The security system comprises the following steps: enrolling a user in the security system by collecting a first item of user biometric data unique to the user; associating the first item of user biometric data with a security authorization for the user; storing the first item of user biometric data and the associated security authorization in a memory device; sensing a second item of user biometric information during the user's swiping of a touchscreen to initialize a mobile device; retrieving the first item of user biometric data and the associated security authorization from the memory device and comparing the first item of user biometric data to the second item of user biometric data to assess the quality of match; granting the user the associated security authorization if the quality of match between the first item of user biometric data to the second item of user biometric data meets a predetermined level; and denying the user the associated security authorization if the quality of match between the first item of user biometric data to the second item of user biometric data does not meet the predetermined level.

In yet another aspect, the storing of the first item of user biometric data and the associated security authorization in a memory device occurs on the mobile device.

In yet another aspect, the storing of the first item of user biometric data and the associated security authorization in a memory device occurs on a network site external to the mobile device.

### BRIEF DESCRIPTION OF THE DRAWINGS

For a more complete understanding, reference is now made to the following description taken in conjunction with the accompanying Drawings in which:

FIG. 1 is a front view of a mobile device having a touchscreen with integrated user biometric sensing in accordance with one embodiment;

FIG. 2 is a side view of the mobile device of FIG. 1; and

FIG. 3 is an enlarged cross-sectional side view of the mobile device of FIGS. 1 and 2 taken through the scanning area.

### DETAILED DESCRIPTION

For purposes of this application, the term mobile device means a touchscreen-equipped mobile device (e.g., smartphone, tablet, handheld, tablet computer or similar device). Examples of such mobile devices include, but are not limited to, Apple® mobile devices using the iOS™ operating system (e.g., iPhone™ brand smartphones, iPad™ brand tablets and some iPod Touch™ brand handhelds), Samsung®, HTC® and other brand smartphones and tablets using the Google® Android® operating system and various smartphones and tablets using the Microsoft® Windows 8™ operating system.

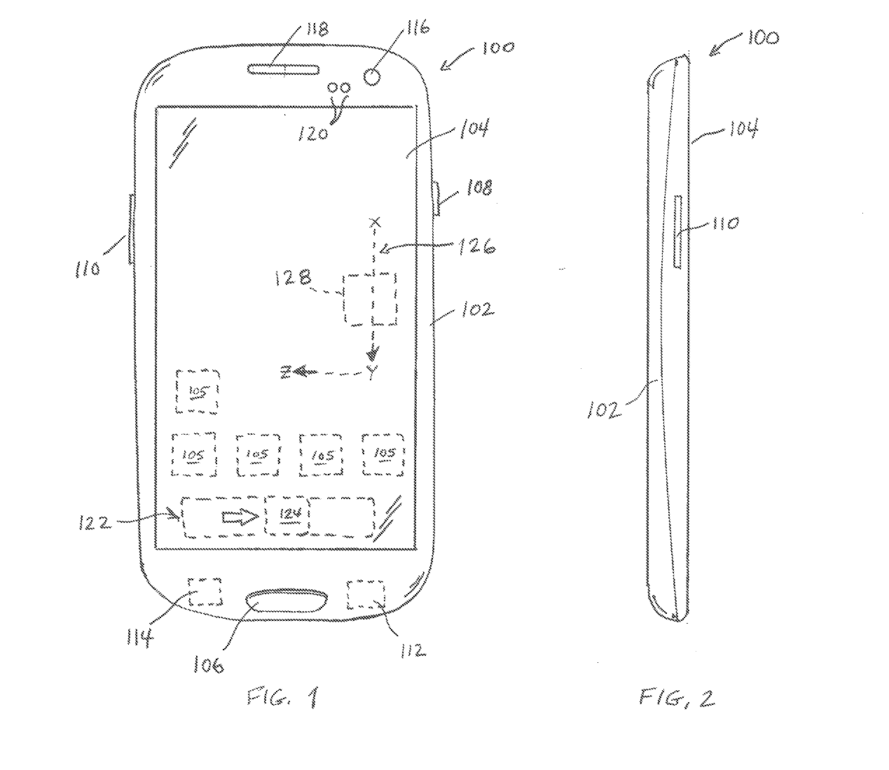

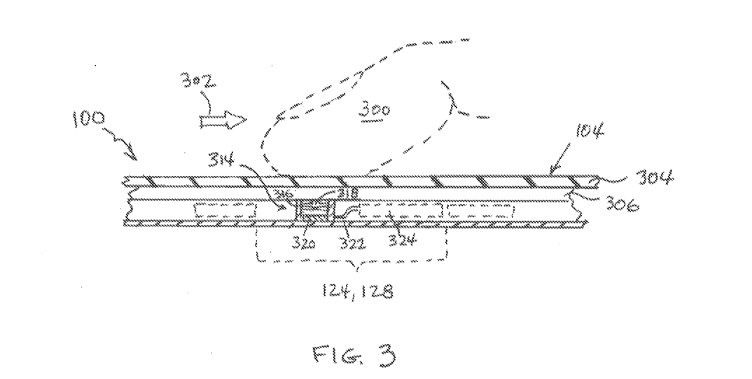

Referring to FIGS. 1 and 2, there is illustrated a mobile device having a touchscreen with integrated user biometric sensing in accordance with one embodiment. In this embodiment, the mobile device is a smartphone; however, in other embodiments, the mobile device may be a tablet, handheld or similar device having a touchscreen. The mobile device 100 includes a casing 102 and a touchscreen 104 mounted on the front side of the casing. The touchscreen 104 serves dual purposes, acting as a display panel for displaying icons 105, text and graphic content (not shown) and, at the same time, acting as a touch-sensitive, digitizing input pad. A HOME button 106 may be mounted on the front side of the casing 102. In some embodiments, the HOME button 106 is mounted through the touchscreen 104 or through the glass plate associated with the touchscreen, while in other embodiments, the HOME button is mounted directly on or through the front side of the casing. In still other embodiments, there is no physical HOME button, although its functionality may be provided by a “virtual” HOME button (not shown) displayed on the touchscreen 104.

The mobile device 100 may further include a power/lock button 108, a volume switch 110, one or more touch-sensitive buttons 112 and 114, one or more cameras 116, one or more speakers 118 and/or one or more sensors 120 (e.g., proximity sensors, light sensors, etc.). The various components of the mobile device 100 are operatively connected to internal components (not shown), which may include circuit boards, processors, memory devices, cellular, Wi-Fi and/or Bluetooth transceivers and/or batteries. Except as otherwise described herein, these components and their functional interconnections are conventional.

Referring still to FIGS. 1 and 2, the components used for integrated user biometric sensing may be disposed within the casing 102 below and/or adjacent to the touchscreen 104 and/or embedded in the touchscreen 104 itself. The exact location and configuration of the components used for integrated user biometric sensing within the mobile device 100 are dependent on the position and form of biometric “presentation” to be made by the user. In preferred embodiments, the presentation of biometric data is incorporated into the normal “finger-swipe process” of device initiation, thereby allowing the mobile device to simultaneously perform biometric verification (or at least, to sense user biometric data) at the time of initiation (i.e., at swipe).

An associated security system may then use the sensed biometric information to verify the authenticity of the user and make available on an “assigned rights” basis access to some or all secured content including, files, contacts, images, photos, user names, passwords, etc., that have been administratively assigned with a local application and/or a remote agent. Technology disclosed in U.S. Pat. No. 7,519,558 to Ballard et al. may be utilized in the security system. In some embodiments, the associated security system may be entirely disposed within the circuitry of the mobile device 100; whereas in other embodiments, the associated security system may be distributed between the mobile device and an external network location (e.g., a security server).

In one such preferred embodiment, the desired finger-swipe path is represented as a virtual “slide bar” (denoted as 122 in FIG. 1) displayed on the touchscreen and animated to follow the finger-swipe. The biometric sensing components could potentially be disposed at any point along this slide bar path; however, for purposes of example and illustration, the exemplary sensing area of slide bar path 122 is indicted by broken line area 124.

In another such preferred embodiment, the desired finger-swipe path is part of a user-selected two-dimensional touch pattern (denoted as 126 in FIG. 1). In the example shown in FIG. 1, the finger-swipe path 126 goes sequentially from point “X” to point “Y” to point “Z”. The biometric sensing components could potentially be disposed at any point along this finger-swipe path; however, for purposes of example and illustration, the exemplary sensing area of path 126 is indicted by broken line area 128. Typically, the sensing areas 124 and 128 of FIG. 1 would be alternative, i.e., only one such area would be present. However, some embodiments may include multiple biometric sensing areas.

Referring now to FIG. 3, there is illustrated an enlarged cross-section view of the mobile device 100 of FIGS. 1 and 2 taken through the sensing area, e.g., one of area 124 or area 128. A fingertip 300 of the user (in broken line) is shown moving across the top surface of the touchscreen 104 in the direction indicated by arrow 302. The touchscreen 104 may include a glass plate 304 and one or more display layers (not shown) and/or touch-sensitive layers (not shown). The display layers and touch-sensitive layers are of conventional constructions and may be discrete (i.e., separate) parts or integral parts of the glass plate 304. A backlight unit 306 may be disposed beneath the touchscreen 104. The backlight unit 306 may be of substantially conventional construction; however, unconventional passages and/or apertures may be provided in the backlight unit to allow for placement and/or light paths to a camera/scanner module 314 as described below.

The camera/scanner module 314 is typically disposed within the casing 102 underneath the touchscreen 104. In some embodiments, the camera/scanner module 314 may be disposed in the backlight unit 306 itself, while in other embodiments it is disposed below the backlight unit. In the illustrated embodiment, the camera/scanner module 314 is located below the backlight unit and looks “through” the backlight unit at the underside of the touchscreen 104 in the sensing area 124 or 128. The camera/scanner module 314 may include a housing 316, a lens array 318, a photo sensor 320 and signal wires/cables 322, which operatively connect the scanner/camera module to sensing/security circuitry 324 disposed within the casing 102 of the mobile device 100. The housing 316 and lens array 318 of the camera/scanner module 314 will be configured in accordance with the shape of the sensing area 124 or 128. The lens array 318 may include one or more lenses as necessary to focus the image received from the top surface of the touchscreen 104 onto the photo sensor 320. The lenses of the lens array 318 may include, but are not limited to: conventional lenses of various configurations; spherical lenses; aspheric lenses; Fresnel lenses; prisms; beam-splitters; filters; polarizers and/or other optical devices useful for bending and/or focusing light. The photo sensor 320 may be a CCD light sensor, a CMOS light sensor, or other type of light sensor.

In operation of the system according to one embodiment, the user moves (i.e., swipes) his/her fingertip 300 across the touchscreen 104 in the sensing region 124 or 128 of the respective swipe pattern 122 or 126. This finger-swiping action initiates unlocking of the device 100 while simultaneously presenting biometric data unique to that user (i.e., a fingerprint or partial fingerprint) to the integrated biometric sensor within or under the touchscreen 104. In the illustrated embodiment, the camera/scanner module 314 records the user's presented biometric data. Specifically, an image of the portion of the finger pressed (or swiped) against the top surface of the touchscreen 104 above the camera/scanner module 314 is transmitted through the touchscreen, focused by the lens array 318 and received by the photo sensor 320. The image information detected by the photo sensor 320 (and containing the user's biometric data) is transmitted via cable 322 to the sensor/security circuitry 324 of the mobile device. The sensor/security circuitry 324 then compares the user biometric data received from the touchscreen 104 to previously stored biometric data corresponding to authorized users of the mobile device. In some embodiments, such comparison may be performed entirely internally in the mobile device 100, whereas in other embodiments such comparison may be performed at least partially via communication with other networked devices, for example a central server or data repository. In some other embodiments, the technology disclosed in U.S. Pat. No. 7,519,558 to Ballard et al. may be utilized in the security system.

In other embodiments (not illustrated), the camera/scanner module may be replaced with a fingerprint sensor embedded directly in the touchscreen. Swiping the user's fingertip across the fingerprint sensor, or alternatively, placing the user's fingertip on the fingerprint sensor allows the user biometric data to be collected for comparison to previously recorded biometric data as previously described.

In another aspect thereof, a security system is provided for a touchscreen-equipped mobile device having a biometric sensor. The security system comprises the following steps:
1) enrolling a user in the security system by collecting a first item of user biometric data unique to the user;
2) associating the first item of user biometric data with a security authorization for the user;
3) storing the first item of user biometric data and the associated security authorization in a memory device;
4) sensing a second item of user biometric information during the user's swiping of a touchscreen to initialize a mobile device;
5) retrieving the first item of user biometric data and the associated security authorization from the memory device and comparing the first item of user biometric data to the second item of user biometric data to assess the quality of match;
6) granting the user the associated security authorization if the quality of match between the first item of user biometric data to the second item of user biometric data meets a predetermined level; and
7) denying the user the associated security authorization if the quality of match between the first item of user biometric data to the second item of user biometric data does not meet the predetermined level.

Although the preferred embodiment has been described in detail, it should be understood that various changes, substitutions and alterations can be made therein without departing from the spirit and scope of the invention as defined by the appended claims.

What is claimed is:

1. A touchscreen-equipped mobile device with integrated user biometric sensing in accordance with the disclosure herein.

2. A mobile device with integrated user biometric sensing, the mobile device comprising:
a casing;
a touchscreen mounted on a front side of the casing, the touchscreen acting as a display panel and, at the same time, acting as a touch-sensitive, digitizing input pad;
a camera/scanner module disposed below the touchscreen in a predefined scanning area, the camera/scanner module including a housing, a lens, a photo sensor and signal wires which operatively connect the scanner/camera module to sensing/security circuitry disposed within the casing;
wherein, when a user presses a fingertip against the top surface of the touchscreen in the scanning area, the lens array focuses an image of a fingerprint of the fingertip from the top surface of the touchscreen onto the photo sensor.

3. A mobile device with integrated user biometric sensing in accordance with claim 2, wherein the mobile device is a smartphone.

4. A mobile device with integrated user biometric sensing in accordance with claim 2, wherein the mobile device is a tablet device or table computer.

5. A mobile device with integrated user biometric sensing in accordance with claim 2, wherein the mobile device is a handheld device.

6. A mobile device with integrated user biometric sensing in accordance with claim 2, wherein after the lens array focuses the image of the fingerprint from the top surface of the touchscreen onto the photo sensor, the photo sensor sends signals representative of the user's biometric data to the sensing/security circuitry of the mobile device.

7. A mobile device with integrated user biometric sensing in accordance with claim 6, wherein after the photo sensor sends signals representative of the user's biometric data to the sensing/security circuitry of the mobile device, the mobile device compares the user's biometric data to previously stored biometric data corresponding to on or more authorized users of the mobile device and/or accounts accessible via the mobile device.

8. A mobile device with integrated user biometric sensing in accordance with claim 7, wherein the comparison of the user's biometric data to previously stored biometric data corresponding to on or more authorized users is performed entirely within the mobile device.

9. A mobile device with integrated user biometric sensing in accordance with claim 7, wherein the comparison of the user's biometric data to previously stored biometric data corresponding to on or more authorized users is performed at least partially via communication with an external networked device.

10. A mobile device with integrated user biometric sensing in accordance with claim 9, wherein the external networked device is a security server.

11. A security system for a touchscreen-equipped mobile device having a biometric sensor, the security system comprising the following steps:
enrolling a user in the security system by collecting a first item of user biometric data unique to the user;
associating the first item of user biometric data with a security authorization for the user;
storing the first item of user biometric data and the associated security authorization in a memory device;
sensing a second item of user biometric information during the user's swiping of a touchscreen to initialize a mobile device;
retrieving the first item of user biometric data and the associated security authorization from the memory device and comparing the first item of user biometric data to the second item of user biometric data to assess the quality of match;
granting the user the associated security authorization if the quality of match between the first item of user biometric data to the second item of user biometric data meets a predetermined level; and
denying the user the associated security authorization if the quality of match between the first item of user biometric data to the second item of user biometric data does not meet the predetermined level.

12. A security system in accordance with claim 11, wherein the storing of the first item of user biometric data and the associated security authorization in a memory device occurs on the mobile device.

13. A security system in accordance with claim 11, wherein the storing of the first item of user biometric data and the associated security authorization in a memory device occurs on a network site external to the mobile device.
